(19) United States
(12) Patent Application Publication
(10) Pub. No.: US 2011/0258708 A1
(43) Pub. Date: Oct. 20, 2011

(54) METHOD, APPARATUS AND COMPUTER PROGRAM PRODUCT FOR CACHING OF CONTENT FROM SERVER

(75) Inventor: Chetankumar KRISHNAMURTHY, Bangalore (IN)

(73) Assignee: NOKIA CORPORATION, Espoo (FI)

(21) Appl. No.: 13/087,041

(22) Filed: Apr. 14, 2011

(30) Foreign Application Priority Data
Apr. 14, 2010 (IN) 1041/CHE/2010

(51) Int. Cl. G06F 21/24

(52) U.S. Cl. 726/29

(57) ABSTRACT

Disclosed are a method, an apparatus and a computer program product. The method includes receiving a server feed from a server for accessing a content stored in the server. The method further includes determining a Unique Identifier (ID) of at least one hierarchical level of the content by parsing the server feed. Further, the method includes comparing the determined UniqueID of the at least hierarchical level of the content to a stored UniqueID of the at least one hierarchical level. Thereafter, the method facilitates for accessing the content based on the comparison of the determined UniqueID to the stored UniqueID.

### CROSS REFERENCE TO RELATED APPLICATIONS

This application claims the benefit of Indian Patent Application No. 1041/CHE/2010 filed on Apr. 14, 2010, the contents of which are expressly incorporated by reference herein.

### TECHNICAL FIELD

The present disclosure generally relates to accessing of content from servers, and more particularly, to accessing content by caching the content transferred from a server.

### BACKGROUND

With the growth of technology, communication and computer networks have become a medium for providing access to tremendous amount of information relating to numerous services, such as telecommunication services, Internet services, and the like. This information may be related to catering services such as social networking services, information retrieval services, entertainment services, gaming services, applications for providing banking services, searching services, e-mail services, news services, multimedia access services, sales and purchase services. Oftentimes, such services are provided by dedicated servers to various data processing devices simultaneously.

For example, many web based services providers such as Picasa™ YouTube™, Flickr®, CNN™ and ESPN™ deliver content such as photos, news, blogs, songs and other multimedia content. Such web based services are provided to clients in form of feeds from their servers as per demands of the clients. Examples of the feeds may include, but are not limited to, RSS feeds and Atom feeds. RSS (or Atom) feeds can be obtained by hitting certain designated links (Uniform Resource Identifiers) specified by the service provider. Such feeds are usually encapsulated in an Extensible Markup Language (xml) format.

These services can be accessed from data processing and communication devices, such as personal computers, digital mobile phones, personal digital assistants (PDAs), and other communication devices. Such devices have the capability to download and access content via sever feeds such as the RSS feeds. The client application's request for content, for example, photos under an album of a user stored in the Picasa server, triggers a server response encapsulated in an XML (basically the RSS (or atom) feed). Links are extracted from the server feed, and subsequent requests are made until album thumbnails and photos are fetched and rendered on screen of the device of the client.

Applications on the devices for accessing the content from the server, especially the Web browser, experience a long delay while waiting for a web page to be loaded from the server and displayed on the client device. The delay may be caused by slow transfer speed of data across the network relative to the data transfer rates from the client computer disk drive, or limitations of the data traffic handling capabilities of the server or the device of the client.

Several caching techniques of the content are widely used for countering the long delay experienced in accessing the content from the servers. Such cached content may be stored locally on the client device, such as on a disk drive. If the browser retrieves a file from a server, the browser saves a copy of the file in the browser cache, for example, the disk drive. If the file is desired to be accessed for the next time, the browser checks the browser cache to see if the requested file is present in the cache. The applications that do not keep track of data explicitly via sever cache modeling or other similar methods; make repeated queries to the server for data validation and coherency. This leads to increased network usage.

Presently used content providing applications models server cache for improving speed, user interaction and efficient utilization of network bandwidth. These applications utilize a local disk or other data storage mechanism for book-keeping of the cached data. This leads to implementation complexity and memory overhead. Further, there are caching techniques that match each resource of the local cache to the resource stored on the server for verifying coherency of the cached content with respect to the server, which increase the overhead and computation complexity.

Based on the foregoing, there is a need of a mechanism for improved caching mechanism that reduces the usage of network bandwidth, and reduces the overhead and computation complexity for verifying coherency of the cached content.

### SUMMARY

A method, an apparatus and a computer program product for caching of content from a server are provided.

According to a first aspect, a method is provided. The method includes receiving a server feed from a server for accessing a content stored in the server. The method further includes determining a Unique Identifier (UniqueID) of at least one hierarchical level of the content by parsing the server feed. Furthermore, the method includes comparing the determined UniqueID of the at least one hierarchical level of the content to a stored UniqueID of the at least one hierarchical level. Thereafter, the method includes facilitating for accessing the content based on the comparison of the determined UniqueID to the stored UniqueID.

In an embodiment, the method facilitates accessing the content by performing one of rendering the content from a storage memory if there is a match between the determined UniqueID and the stored UniqueID, and rendering the content using the server feed if there is a mismatch between the determined UniqueID and the stored UniqueID. In an embodiment, the method further includes updating the stored UniqueID by the determined UniqueID in a storage memory, if there is a mismatch between the determined UniqueID and the stored UniqueID. The method further includes storing the rendered content in the storage memory.

Further, in an embodiment, the method facilitates accessing the content by computing a list of resources using the server feed. The method further includes comparing a list of resources computed using the server feed to a list of resources of the content present in the storage memory. In this embodiment, the method includes performing one of rendering the content from the storage memory if the list of resources computed using the server feed and the list of resources present in the storage memory match, and rendering the content using the server feed if there is a mismatch between the list of resources computed using the server feed and the list of resources present in the storage memory. In this embodiment, the method includes updating the list of resources present in the storage memory by the list of resources computed using the server feed, if there is a mismatch between the list of resources computed using the server feed and the list of resources present in the storage memory. In an embodiment, the content may be a photo. In this embodiment, the at least one hierarchical level of image includes a collection, one or more albums within the collection, and one or more photos within each album.

According to another aspect, an apparatus is provided. The apparatus includes at least one processor, and at least one memory including computer program code. At least one memory and the computer program code are configured to, with at least one processor, cause the apparatus to at least perform: receive a server feed from a server for accessing a content stored in the server; determine a Unique Identifier (UniqueID) for at least one hierarchical level of the content by parsing the server feed; compare the determined UniqueID of the at least one hierarchical level of the content to a stored UniqueID of the at least one hierarchical level; and facilitate for accessing the content based on the comparison of the determined UniqueID to the stored UniqueID.

In an embodiment, the apparatus further include a storage memory, wherein the at least one memory and the computer program code is configured to, with the at least one processor, cause the apparatus to at least facilitate for accessing the content by performing one of rendering the content from the storage memory if there is a match between the determined UniqueID and the stored UniqueID, and rendering the content using the server feed, if there is a mismatch between the determined UniqueID and the stored UniqueID.

In an embodiment, the at least one memory and the computer program code and the at least one processor are configured to cause the apparatus to update the stored UniqueID by the determined UniqueID in the storage memory, if there is a mismatch between the stored UniqueID and the determined UniqueID. Further, the least one memory, the computer program code and the at least one processor are configured to cause the apparatus to store the rendered content in the storage memory.

In an embodiment, the at least one memory and the computer program code with the at least one processor, are configured to cause the apparatus to at least facilitate for accessing the content by computing a list of resources of the content using the server feed. Further, the at least one memory and the computer program code with the at least one processor, are configured to cause the apparatus to compare the list of resources computed using the server feed to a list of resources present in a storage memory. In this embodiment, the at least one memory and the computer program code with the at least one processor are configured to cause the apparatus to perform one of rendering the content from the storage memory if there is a match between the list of resources computed using the server feed and the list of resources in the storage memory, and rendering the content using the server feed if there is a mismatch between the list of resources computed using the server feed and the list of resources in the storage memory. In this embodiment, the at least one memory, the computer program code and the at least one processor are further configured to cause the apparatus to at least update the list of content present in the storage memory by the list of resources computed using the server feed, if there is a mismatch between the list of resources using the server feed and the list of resources in the storage memory. In an embodiment, the content is a photo, and the at least one hierarchical level of the content includes a collection, one or more albums within each collection, and one or more photos within each album.

Further, in an embodiment, the at least one memory, the computer program code and the at least one processor are configured to cause the apparatus to at least determine the UniqueID by hashing of timestamp associated with the at least one hierarchical level of the content and a feed portion corresponding to the at least one hierarchical level of the content in the server feed.

According to a yet another aspect, a computer program product is provided. The computer program product includes at least one computer-readable storage medium, the computer-readable storage medium including a set of instructions configured to cause the apparatus to at least: receive a server feed from a server for accessing a content stored in the server; determine a Unique Identifier (ID) for at least one hierarchical level of the content by parsing the server feed; compare the determined UniqueID to a stored UniqueID of the at least one hierarchical level; and facilitate accessing the content based on the comparison of the determined UniqueID to the stored UniqueID.

In an embodiment, the set of instructions are further configured to cause the apparatus to facilitate accessing the content by performing one of rendering the content from a storage memory if there is a match between the determined UniqueID and the stored UniqueID; and rendering the content using the server feed if there is a mismatch between the determined UniqueID and the stored UniqueID. In this embodiment, the set of instructions are further configured to cause the apparatus to at least perform updating the stored UniqueID by the determined UniqueID in the storage memory, if there is a mismatch between the determined UniqueID and the stored UniqueID. In this embodiment, the set of instructions are further configured to cause the apparatus to at least perform storing the rendered content in the storage memory.

In an embodiment, the set of instructions are further configured to cause the apparatus to facilitate accessing the content by computing a list of resources of the content using the server feed, and comparing the list of resources of the content computed using the server feed to a list of resources of the content present in the storage memory. Further, the set of instructions are further configured to cause the apparatus to perform one of rendering the content from the storage memory if there is a match between the list of resources using the server feed and the list of resources present in the storage memory, and rendering the content using the server feed if there is a mismatch of the list of resources computed using the server feed and the list of resources present in the storage memory. In this embodiment, the set of instructions are further configured to cause the apparatus to at least update the list of resources present in the storage memory by the list of resources computed using the server feed, if there is a mismatch between the determined UniqueID and the stored UniqueID. Further, the set of instructions are further configured to cause the apparatus to at least determine the UniqueID by may be hashing of timestamp associated with the at least hierarchical level of the content and a feed portion corresponding to the at least one hierarchical level of the content in the server feed.

These and other features of the present disclosure will be apparent upon consideration of the following detailed description of preferred embodiments.

### BRIEF DESCRIPTION OF THE DRAWINGS

The above-mentioned and other features and advantages, and the manner of attaining them, will become more apparent by reference to the following description of embodiments taken in conjunction with the accompanying drawings, wherein:

FIG. 1 is a block diagram of an exemplary environment in which various embodiments can be practiced;

FIG. 2 illustrates an schematic representation of hierarchical levels of content;

FIG. 3 illustrates a flow diagram of a method for caching of content from a server, according to an embodiment;

FIGS. 4A and 4B illustrate a flow diagram of a method for caching of content such as photo from the server, according to an embodiment; and

FIG. 5 illustrates an apparatus for caching of content from a server, according to an embodiment.

The method and the apparatus have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Before describing in detail embodiments that are in accordance with the present disclosure, it should be observed that the embodiments reside primarily in combinations of method steps and apparatus components related to caching of content from a server.

In this document, the terms “comprises,” “comprising,” or any other variation thereof, are intended to cover a non-exclusive inclusion, such that a process, method, article, apparatus or apparatus that comprises a list of elements does not include only those elements but may include other elements not expressly listed or inherent to such process, method, article, apparatus, or apparatus. An element proceeded by “comprises . . . a” does not, without more constraints, preclude the existence of additional identical elements in the process, method, article, apparatus or apparatus that comprises the element.

Any embodiment described herein is not necessarily to be construed as preferred or advantageous over other embodiments. All of the embodiments described in this detailed description are illustrative, and provided to enable persons skilled in the art to make or use the disclosure and not to limit the scope of the disclosure, which is defined by the claims.

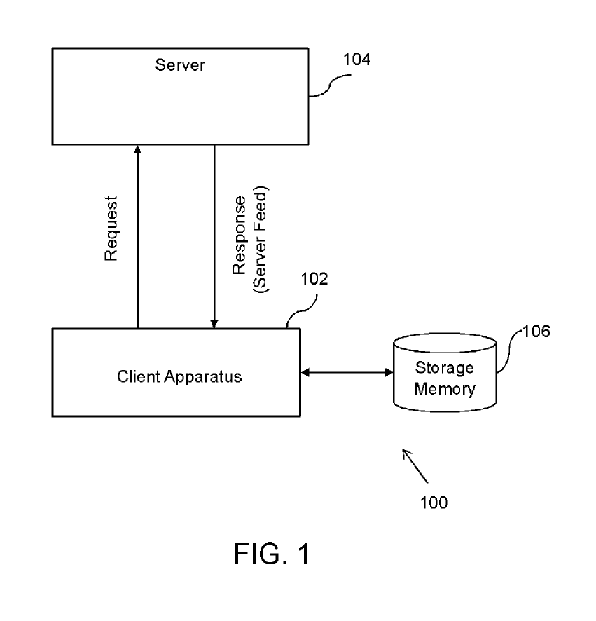

As illustrated in FIG. 1, an environment 100 including basic request-response mechanism between a client apparatus 102 and a server 104 is shown. The client apparatus 102 may be a data processing apparatus, such as personal compute, laptops, mobile phone, Personal Digital Assistant (PDA), or any other apparatus that can be used by the client to communicate and exchange content from the server 104. The client apparatus 102 may be connected to the server 104 through communication networks known in the art, such as cellular network in compliant with communication protocols such as IS-136 (TDMA), GSM, IS-95 (CDMA), GPRS, Enhanced Data GSM Environment (EDGE), Universal Mobile Telephone System (UNITS), WiMAX and network employing Wideband Code Division Multiple Access (WCDMA), and Wide Area Network (WAN), Metropolitan Area Network (MAN), Local Area Network (LAN), Campus Area Network (CAN), Wi-Fi network, and the like.

As shown in FIG. 1, the client apparatus 102 requests for accessing the content stored at the server 104. Herein, accessing the content may include downloading, rendering, browsing, or selective downloading of the content, forwarding or retrieving information pertaining to the content, and the like. The server 104 may be a device that stores the content, and is accessible by the client apparatus 102 through any of the networks such as cellular networks, WAN, LAN, MAN, Wi-Fi, and the like. For example, the server 104 may be a web server having a single or multiple servers. The web server may be configured to provide content through any Internet service applications, native applications, widgets and the like. Examples of the Internet services applications being provided by the server 104 may include, but are not limited to social networking services, information retrieval services, entertainment services, gaming services, applications for providing banking services, searching services, e-mail services, news services, multimedia access services, sales and purchase services. The client apparatus 102 may request for accessing the content from the server 104 by opening certain designated link specified for the server 104. For example, the client apparatus 102 may open a particular Uniform Resource Identifier (URI) designated for the server 104 that stores the content desired by user of the client apparatus 102.

In an embodiment, the server 104 may provide a response of the request from the client apparatus 102 in form of feeds from the server 104. Hereinafter in this description, the feeds from the server may be referred to as ‘server feeds’. Examples of the server feeds may include, but are not limited to, Really Simple Syndication (RSS) feeds and ‘Atom’ feeds. It should be pointed out that the server 104 typically performs complex database functions in order to retrieve the requested information and package for the content in an outbound Extended Markup Language (XML) response. The XML response encapsulates the server feeds. Alternatively, other formats may also be used to provide server feeds to the client apparatus 102. The server feeds may be any manifests generated from the server 104 that are used for the presenting the content to the client apparatus 102. Herein, the content is typically stored on the server 104 in a hierarchical data arrangement. For example, content such as photos may be stored under albums, and albums may further be stored in a particular collection. The server feeds include identifiers (IDs) for each of these hierarchical levels of the content. Links of the content may be extracted from the server feeds, and subsequent requests are made until content is fetched and rendered on the screen. Further, the content may be stored in a storage memory 106. Examples of the storage memory 106 may include any storage apparatus, a server, or a cache memory. The storage memory 106 acts as a local cache for the client apparatus 102 and will be hereinafter interchangeably referred to as ‘local cache’. The storage memory 106 is shown as a separate entity from the client apparatus 102 in FIG. 1, however it should not be considered limiting. The storage memory 106 for example, the local cache can be a part of the client apparatus 102.

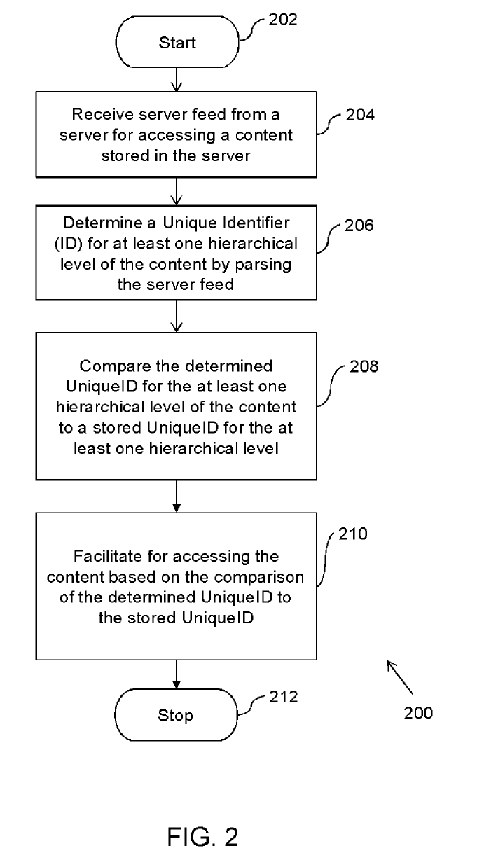

Referring to FIG. 2, a method 200 of caching content from a server is shown, in accordance with an embodiment. The method 200 of caching content from the server such as the server 104 can initiate at 202. At 204, a feed from the server 104 (hereinafter referred to as “server feed”) is received at the client apparatus 102. The server feed is received for accessing the content corresponding to the server feed. Herein, in an embodiment, receiving the server feed may refer to receiving a package that includes the server feed. The package may include information corresponding to the content, and links to the resources of the content. Further, the server feed may be encapsulated in suitable formats such as the XML format. In an embodiment, the content may include any data that may be organized in a hierarchical data arrangement, and may be associated with timestamps. Examples of the content may include, but are not limited to, photos, videos, pod casts, news, animations, blog entries and live updates.

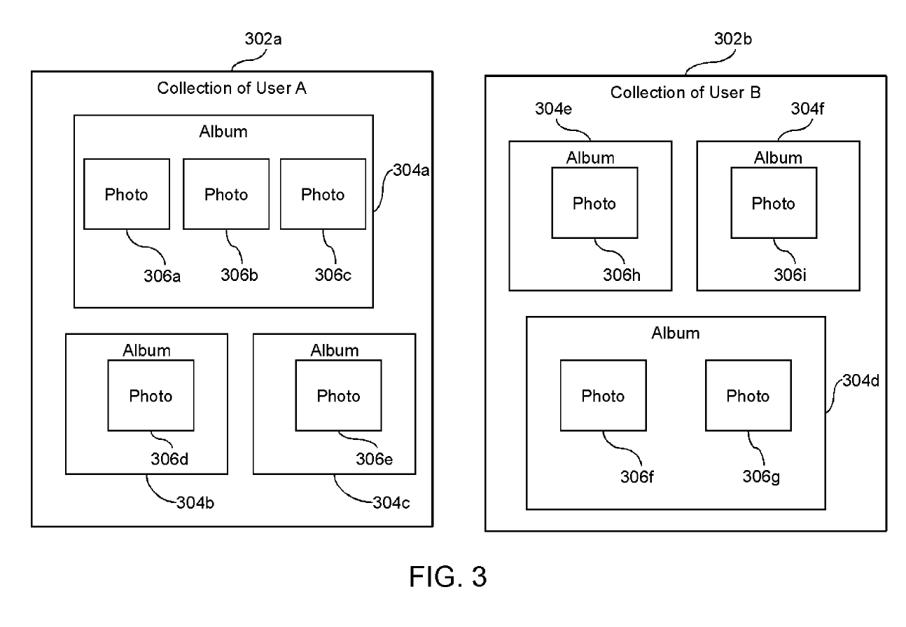

Further, at 206, a UniqueID of at least one hierarchical level of the content is determined by parsing the server feed. The content may be stored in the server 104 in form of a hierarchical data arrangement. An exemplary representation of a hierarchical data arrangement of the content is shown in FIG. 3. In this exemplary representation, the content is shown as photos that may be stored at the server 104. In FIG. 3, collections 302a and 302b are also shown, and these collections may represent collection of photos belonging to particular users. For example, the collection 302a may belong to user A and the collection 302b may belong to user B. Further, each of the users may create/store one or more sets of photos (albums) within his/her collection. For example, the user A may have albums such as New Year party, Birthday Bash, Trip to Mountain, and the like, where each of these albums may include one or more photos.

For example, the collection 302a includes one or more albums of photos such as album 304a, 304b and 304c. Similarly, the collection 302b includes one or more albums such as albums 304d, 304e and 304f. Each of these albums may be organized in separate folders within the collection 302a, and 302b. Accordingly, the user A has three albums 304a, 304b and 304c within the collection 302a at the server 104. Similarly, the user B has stored three albums 304d, 304e and 304f within the collection 302b.

Further, each of the albums may include one or more photos stored by the users. For example, album 304a may include one or more photos such as photos 306a, 306b and 306c, the album 304b include a photo 306d, and the album 304c includes a photo 306e. Similarly, the album 304d may include one or more photos such as photos 306f and 306g, the album 304e include a photo 306h, and the album 304f includes a photo 306i. Accordingly, it would be apparent a person skilled in the art that the content may be organized in form of hierarchical storage. Each hierarchical level of the content may be represented by an identifier (ID) in the server feed. For example, first hierarchical level of the photos, such as the collections 302a and 302b may be represented with particular collections IDs in the server feed. Second hierarchical level of the photos, such as the albums 304a-304f may be represented by particular SetIDs. Third hierarchical level of the photos, such as the photos 306a-306i may be represented by their particular PhotoIDs. Though, there are only three levels of the content are shown in FIG. 2, it would be apparent to those skilled in the art that the content can also be organized in more or fewer number of hierarchical levels in the server 104. Further, various levels of the content are shown in FIG. 2, by assuming the content as photos of users, however multiple hierarchical levels of other content such as videos, blog entries, news content and podcasts may also be represented.

In an embodiment, UniqueIDs for a hierarchical level may be determined by parsing the server feed. For example, by parsing the server feed, timestamp associated with the hierarchical level and related feed portion corresponding to the hierarchical level may be obtained. Further, the UniqueID of the hierarchical level may be determined, for example, by hashing of timestamp associated with the hierarchical level of the content and the ID of the hierarchical level derived from the feed portion corresponding to the hierarchical level of the content in the server feed. For example, UniqueCollectionID may be determined using the server feed. Typically, the UniqueCollectionID is same as the CollectionID. In one embodiment, the CollectionID will be same as UserID. The UserID is specific to a particular user for storing his/her content in the server 104. UniqueID of the set 304a (hereinafter referred to as ‘UniqueSetID’) may be determined by hashing the time stamp associated with the set 304a and the SetID of the set 304a in the server feed. In one embodiment, a UniqueSetCollectionID may be determined by hashing the CollectionID (or the UniqueCollectionID) and UniqueSetIDs under the collection 302a. For example, UniqueSetCollectionID of the collection 302a may be determined by hashing the CollectionID (or the UniqueCollectionID) of the collection 302a and the UniqueSetIDs for the sets 304a, 304b and 304c. Further, UniquePhotoID of the each photo 306a may be determined by hashing of the PhotoID of the photo 306a and the timestamp associated with the photo 306a. UniquePhotoSetID of the set 304a may be determined by hashing the UniqueSetID of 304a with the UniquePhotoIDs of 306a-c. In one embodiment, the UniqueIDs for the hierarchical levels will be the UniqueCollectionID, the UniqueSetCollectionID and the UniquePhotoSetID.

Referring again to FIG. 2, at 208, the determined UniqueID of the hierarchical level is compared with a stored UniqueID of the hierarchical level. It should be noted that the UniqueID can be determined on a real time basis at 206, and the determined UniqueID is compared against the store UniqueID of the hierarchical level. Herein the stored UniqueID represents the latest determined UniqueID that is stored in the storage memory 106, for example, the local cache. In one embodiment, it may be determined that whether the content has been changed or not based on the comparison of the determined UniqueID on a real time basis and the stored UniqueID of one or more hierarchical levels of the content. It should be noted that in case of change in any collection, set, or photo, their corresponding UniqueIDs are also changed. Accordingly, any changes in the content stored in the local cache (storage memory 106) and that in the server 104 may be identified based on the comparison of the determined UniqueID and the stored UniqueID of one or more hierarchical levels of the content.

In an embodiment, UniqueIDs for particular hierarchical levels can be stored and their related data in the storage memory 106 in a manner such that stored UniqueIDs can be compared conveniently with the UniqueIDs determined in a real time basis. For example, when data and UniqueSetID related to the set 304a is extracted from the server feed, a folder in the name of UniqueSetID of the set 304a may be created in the storage memory 106. In an embodiment, a particular set may also be represented by a thumbnail image. The thumbnail image corresponding to the set 304a may also be derived from the server feed. In an embodiment, a UniqueThumbnailID may be determined by hashing the UniqueSetID and a thumbnail resource ID present in the server feed. Further, the thumbnail image associated with the set may be stored as a file with name of UniqueThumbnailID in the folder of UniqueSetID. In another embodiment, the UniqueThumbnailID may also be determined by hashing the timestamp and the thumbnail resource ID. Further, photos of a particular set that are fetched from the server, are stored with names of their UniquePhotoID within the folder of the particular set. This kind of setup makes the generation of UniqueID lists from storage memory 106, less complex.

Once the determined UniqueIDs and the stored UniqueIDs are compared for one or more hierarchical levels of the content, the method 200 may facilitate access of the content based on this comparison at 210. Herein, facilitating access of the content may refer to rendering or displaying the content onto a display screen of the client apparatus 102. It should also be noted that rendering may also include downloading/fetching any information or resources from the package of the content from the server 104. For example, the resources such as photo files may be downloaded from the server 104 and thereafter displayed at the screen of the client apparatus 102. In one form, rendering may also include playing back the content at the client apparatus 102 if the content is multimedia file such as any audio/video file.

In an embodiment, the content is rendered or displayed from the storage memory 106 if there is a match between the determined UniqueID and the stored UniqueID of the hierarchical level. It should be understood that the determined UniqueID and the stored UniqueID may be matched for one or more hierarchical levels of the content depending upon the type of the content. In an embodiment, only two hierarchical levels such as determined and stored UniqueCollectionIDs, and determined and stored UniqueSetCollectionIDs may be matched, and it may be inferred that the content has not been changed or modified, and the content may be directly accessed from the local cache. In another example, all three hierarchical levels, the determined and the stored UniqueCollectionIDs, the determined and the stored UniqueSetCollectionIDs, and the determined and the stored UniquePhotoSetIDs may be matched to ensure that there are no changes in the content of the particular collection. Thereafter, the content may be directly accessed from the local cache.

Further, in this embodiment, the content is rendered using the server feed if there is a mismatch between the determined UniqueID and the stored UniqueID of one or more hierarchical levels. In an embodiment, if it is determined that the determined UniqueIDs do not match with the stored UniqueIDs, the missing or modified part of the content are identified. For example, missing sets may be identified and are then fetched from the server feed, and rendered on the screen of the client apparatus 102. In an embodiment, the missing thumbnails associated with the missing sets may also be identified and fetched using the server feed. At the end of this matching process for one or more hierarchical levels, all the missing sets and their associated thumbnails are identified and rendered at the screen of the client apparatus 102 using the server feed. A person skilled in the art would appreciate that while comparing the determined UniqueIDs and the stored UniqueIDs, only missing part of the content are rendered using the server feed, whereas the matching part of the content are rendered from the local cache (storage memory 106). Further if the content such as the sets of the photos are rendered using the server feed, the stored UniqueIDs in the storage memory 106 are updated with the determined UniqueIDs. Further, the information or any resource pertaining to the content that is fetched using the server feed, are also stored in the storage memory 106, which serves as a cached content for next access of the content by the client apparatus 102.

In an embodiment, the method 200 may identify the missing or modified part of content by comparing a list of resources of the content computed from the sever feed to a list of resources of the content present in the local cache (the storage memory 106). For example, a list of resources such as list of photo files may be computed using the server feed. In an embodiment, the list of photo files may be computed as a list of UniquePhotoIDs. The list of UniquePhotoIDs is compared with the list of UniquePhotoIDs (may be filenames) present in the local cache. Based on the comparison of the list of UniquePhotoIDs determined using the server feed and that stored in the local cache, matching photos and missing photos may be determined.

Accordingly it would be apparent to those skilled in that art that the resources of the content (for example the photo files) will be rendered from the local cache in case the list of resources of the content using the server feed and the list of resources of the content present the local cache match, for example, it is determined that there are no missing or modified content in the server feed. Further, if it is determined that the list of resources computed using the server feed and the list of resources present the local cache do not match, the resources of the content may be rendered using the server feed. In one embodiment, the resources of the content may be rendered from designated links for the resources in the server feed. Further, herein, it should be noted that in one embodiment, only missing resources of the list of resources are rendered from the server, whereas the matching resources of the list of resources may be directly rendered from the local cache. In this embodiment, the list of resources of the content present in the local cache is updated by the list of resources of the content computed using the server feed, if the content is rendered using the server feed. Once, the entire list of resources of the content is rendered at the client apparatus 102, the method 200 can terminate at 212.

It would be apparent to those skilled in the art that some embodiments provide determining the UniqueIDs for the collections, the sets and the photos within the sets. These determined UniqueIDs are stored in the local cache. Further, when a user navigates back and forth between different collections in a real time scenario, the UniqueIDs are re-determined by parsing the server feeds. These UniqueIDs determined using the server feeds are compared with corresponding UniqueIDs stored in the local cache. For example, the CollectionID determined using the server feed and the CollectionID stored in the local cache may be compared. Similarly, the UniqueSetCollectionIDs and the UniquePhotoSetIDs may also be compared. If there is a match, the content such as the sets and photos may be directly rendered from the local cache. Further, in case of any mismatch, the UniqueIDs for the collections, sets and photos may be stored at the local cache, and the information, resources pertaining to the content is rendered using the server feed 104.

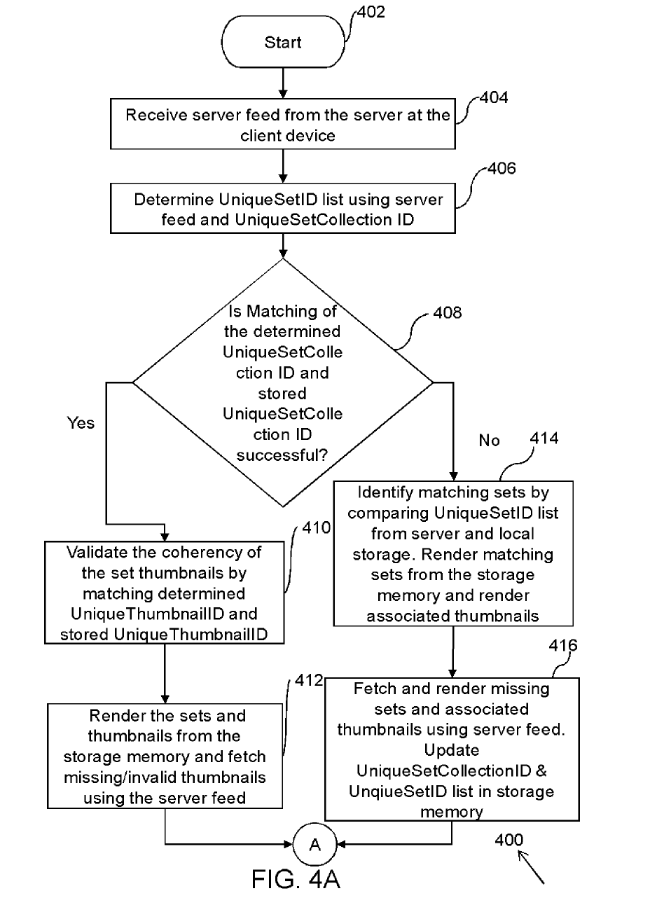

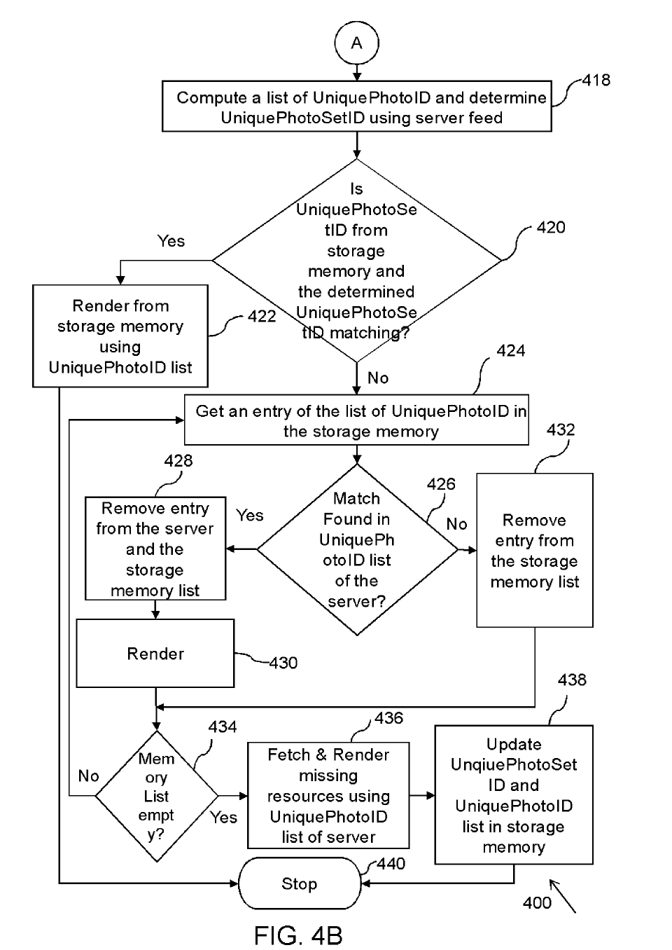

The method provided by the present invention may be further explained by an exemplary embodiment described in conjunction with FIGS. 4A and 4B.

Reference is now made to FIGS. 4A and 4B, which represent a flowchart of a method 400 of caching of content from a server, in accordance with an embodiment. For the description of FIGS. 4A and 4B, the content is assumed to be photos stored in one or more sets of a collection in the server 104. However, it should be noted that the method 400 will be applicable to other type of content as well that use hierarchical data organization and are associated with timestamps. A method 400 for caching the content or accessing the content from the server 104 can initiate at 402. At 404, server feed for the accessing the content is received at the client apparatus 102 from the server 104.

At 406, UniqueIDs for the one or more hierarchical levels are determined. For example, UniqueCollectionIDs, UniqueSetCollectionIDs and the UniquePhotoSetIDs are determined. These UniqueIDs are determined using the server feed. In case the user browses through different collections of the photos, or in subsequent browsing wishes to view the same set of photos within a particular collection, a list of sets of photos for the desired collection is retrieved from the server 104. As explained in FIG. 1, the list of sets may be retrieved in form of the server feed such as XML, encapsulated RSS or Atom feeds. The server feed such the RSS feed for a list of sets under the collection is fetched from the web server 104. In one embodiment, the UniqueCollectionID is a CollectionID of a particular user. Typically, the CollectionID is inherently Unique in the server feed and is User ID in the server feed. Further, in an embodiment, the UniqueSetID may be determined by hashing the SetID and the time stamp associated with the set available in the server feed. Further, the UniqueSetCollectionID may be determined by hashing the CollectionID and one or more UniqueSetIDs under the collection.

When the user initiates a photo viewing process through the client apparatus 102, the user clicks on a designated link to access the sets of photos (albums) within a particular collection. Accordingly, the client apparatus 102 receives the response from the server 104 in form of the server feeds such as the RSS feed for albums listing under the collection. For the sake of this description, an example of the server feed is provided below:

<item>
<guid

isPermaLink=“false”>http://picasaweb.google.com/data/entry/base/user/username/albumid/
5376081899425050153?alt=rss&hl=en_US</guid>

<pubDate>Sat, 22 Aug 2009 03:25:40 +0000</pubDate>
<atom:updated>2009-08-31T11:11:38.050Z</atom:updated>

<category

domain=“http://schemas.google.com/g/2005#kind”>http://schemas.google.com/photos/200
7#album</category>

<title>My Party</title>
<description><table><tr><td style=“padding: 0 5px”><a

href=“http://picasaweb.google.com/Client/Myparty”><img style=“border:1px solid
#5C7FB9”
src=“http://lh6.ggpht.com/_WS2bxyG_TbQ/SpuuAPqjB_E/AAAAAAAABi4/1xbb1fMdB-
4/s160-c/Myparty.jpg” alt=“My party”/></a></td><td valign=“top”><p><font
color=“#333333”></font></p><font color=“#6B6B6B”>Date: </font><font
color=“#333333”>Aug 21, 2009</font><br/><font color=“#6B6B6B”>Number of Photos
in Album: </font><font color=“#333333”>77</font><br/><p><a
href=“http://picasaweb.google.com/Client/Myparty”><font color=\“#3964C2\”>View
Album</font></a></p></td></tr></table></description>

<link>http://picasaweb.google.com/Client/Myparty</link>
<author>Client</author>
<media:group>
<media:content

url=“http://lh6.ggpht.com/_WS2bxyG_TbQ/SpuuAPqjB_E/AAAAAAAABi4/1xbb1fMdB-
4/Myparty.jpg” type=“image/jpeg” medium=“image” />

<media:credit>Client</media:credit>
<media:description type=“plain” />
<media:keywords />
<media:thumbnail

url=“http://lh6.ggpht.com/_WS2bxyG_TbQ/SpuuAPqjB_E/AAAAAAAABi4/1xbb1fMdB-
4/s160-c/Myparty.jpg” height=“160” width=“160” />

<media:title type=“plain”>Myparty</media:title>
</media:group>
</item>

From the above feed, it can be determined that the SetID (for example, AlbumID) is ‘5376081899425050153’, and the name of the album is ‘Myparty’. Herein, in one form, the UniqueSetID may be determined by hashing the SetID (5376081899425050153) and the time stamp (available in <pubDate/>) associated with this set in the above server feed. Further, the UniqueSetCollectionID may be determined by hashing the CollectionID and UniqueSetIDs under the collection. In the above example of server feed, only one SetID (5376081899425050153) is mentioned, hence UniqueSetCollectionID may be determined by hashing the CollectionID and the UniqueSetID of the set 5376081899425050153. The collectionID in this case, can be the user ID. In one embodiment, the album thumbnail may also be retrieved using the link in the <media:thumbnail/> section.

Further at 408, the UniqueSetCollectionID determined using the server feed is matched with the UniqueSetCollectionID stored in the storage memory 106. As described in FIG. 3, the UniqueCollectionID is stored in the storage memory 106 in a folder in the name of UniqueCollectionID and entire sets of under the collection are stored in separate folder in the names of their respective UniqueSetIDs within the UniqueCollectionID folder.

If at 408, it is determined that the UniqueSetCollectionID determined at 406 and the UniqueSetCollectionID stored in the storage memory 106 are same, it may be inferred that new sets have not been added to the collection, and neither have they been deleted from the collection stored on the server 104. So the coherency of albums under the collection stored on the server 104 with that of the local cache, for example, the storage memory 106 is established.

In one embodiment, this coherency may further be validated by matching UniqueThumbnailIDs determined using the server feed and the UniqueThumbnailIDs stored in the storage memory 106. Accordingly, at 410, this is validated by matching UniqueThumbnailIDs determined using the server feed and UniqueThumbnailIDs stored locally on the storage memory 106. As described in FIG. 3, a thumbnail image associated with a set is fetched from the corresponding link in the server feed, and is stored in the corresponding set folder using UniqueThumbnailID as the name of file. Herein, in one embodiment, the UniqueThumbnailID may be determined by performing a hashing of the UniqueSetID with the thumbnail resource identifier present in the server feed. In another embodiment, the UniqueThumbnailID may also be determined by hashing the timestamp and the thumbnail resource ID.

Further, once the coherency is validated by comparing the UniqueThumbnailIDs from the local cache and UniqueThumbnailIDs determined using the server feed, the matching thumbnails and their sets are rendered immediately from the storage memory 106 at 412. Further, the invalid or missing thumbnails are rendered using the server feed from the server 104, at 412. The invalid or missing thumbnails fetched from the server 104 are stored on the storage memory 106.

Further, at 408, if it is determined that the UniqueSetCollectionID determined using the server feed do not match with the UniqueSetCollectionID stored in the storage memory 106, the method 400 proceeds to 414. At 414, the matching sets between the storage memory 106 and the server 104 are identified. This can be done by preparing a list of UniqueSetIDs from corresponding information in the server feed. It should be noted that the sets are stored in the storage memory 106 in the folder having names of their UniqueSetIDs. The list of UniqueSetIDs may be compared with the folder names (of sets) in the storage memory 106 one by one. Matching entries are removed from the list of UniqueSetIDs computed using the server feed. Matching entries may refer that the sets of these entries have not been changed. In one embodiment, matching sets may be further validated by matching the UniqueThumbnailIDs of the matching sets determined using the server feed and stored in the storage memory 106. The UniqueThumbnailIDs are stored in the storage memory 106 in form of the filenames of the thumbnail data in the folders related to their corresponding sets.

Once the matching thumbnails are identified, their corresponding sets may be rendered immediately on the screen of the client apparatus 102 from the local cache, (the storage memory 106). Further, the missing or invalid thumbnails may be fetched from the server 104 and are stored in the storage memory 106. These thumbnails are also rendered on the screen of the client apparatus 102.

Further, after the completion of the identification of the matching sets at 414, each of the matching sets is removed from the list of the UniqueSetIDs computed using the server feed. It will be apparent to those skilled in the art that the entries left in the list of the UniqueSetIDs are missing or modified sets. Such missing or modified sets are rendered using the server feed from the server 104, and also stored in the local cache. Furthermore, the associated thumbnails for the missing sets are also fetched from the server 104, stored in the local cache and rendered at the screen of the client apparatus 102. At the end of this matching process, all the valid set thumbnails are identified, saved onto the local cache, and rendered on the screen of the client apparatus 102.

Once the rendering of the sets is complete, and the user makes a selection of a set to view the photo(s) inside the selected set, the server feed such as RSS (or atom) feed describing the photo(s) under the selected set are fetched from the server 104. Further, at 418, a UniquePhotoID list is generated by parsing the server feed.

In the exemplary representation of the RSS feed provided above, link to the RSS (or atom) feed for the album information (listing of photos, etc.) is available in the <link/> section of the exemplary feed. Using this link, the RSS feed for the album (set) 5376081899425050153 is retrieved, and is represented in an exemplary format as follows:

| | |
|---|---|
| − | <item> |
| | <guid |

isPermaLink=“false”>http://picasaweb.google.com/data/entry/base/user/client/albumid/53760
81899425050153/photoid/5376081917770635346?alt=rss&hl=en_US</guid>

<pubDate>Mon, 31 Aug 2009 11:03:33 +0000</pubDate>
<atom:updated>2009-08-31T11:03:33.128Z</atom:updated>
<category

domain=“http://schemas.google.com/g/2005#kind”>http://schemas.google.com/photos/2007#
photo</category>

<title>IMG_1101.JPG</title>
<description><table><tr><td style=“padding: 0 5px”><a

href=“http://picasaweb.google.com/client/Myparty#5376081917770635346”><img
style=“border:1px solid #5C7FB9”
src=“http://lh3.ggpht.com/_WS2bxyG_TbQ/SpuuBUAemFI/AAAAAAAABeE/1X_XIfxYSF
E/s288/IMG_1101.JPG” alt=“IMG_1101.JPG”/></a></td><td valign=“top”><font
color=“#6B6B6B”>Date: </font><font color=“#333333”>Aug 22, 2009 1:55
AM</font><br/><font color=\“#6B6B6B\”>Number of Comments on Photo:</font><font
color=\“#333333\”>0</font><br/><p><a
href=“http://picasaweb.google.com/client/Myparty#5376081917770635346”><font
color=“#3964C2”>View Photo</font></a></p></td></tr></table></description>

<enclosure type=“image/jpeg”

url=“http://lh3.ggpht.com/_WS2bxyG_TbQ/SpuuBUAemFI/AAAAAAAABeE/1X_XIfxYSF
E/IMG_1101.JPG” length=“0” />

| | |
|---|---|
| | <link>http://picasaweb.google.com/client/Myparty#5376081917770635346</link> |
| − | <media:group> |
| | <media:content |

url=“http://lh3.ggpht.com/_WS2bxyG_TbQ/SpuuBUAemFI/AAAAAAAABeE/1X_XIfxYSF
E/IMG_1101.JPG” height=“768” width=“1024” type=“image/jpeg” medium=“image” />

<media:credit>Client</media:credit>
<media:description type=“plain” />
<media:keywords />
<media:thumbnail

url=“http://lh3.ggpht.com/_WS2bxyG_TbQ/SpuuBUAemFI/AAAAAAAABeE/1X_XIfxYSF
E/s72/IMG_1101.JPG” height=“54” width=“72” />

<media:thumbnail

url=“http://lh3.ggpht.com/_WS2bxyG_TbQ/SpuuBUAemFI/AAAAAAAABeE/1X_XIfxYSF
E/s144/IMG_1101.JPG” height=“108” width=“144” />

<media:thumbnail

url=“http://lh3.ggpht.com/_WS2bxyG_TbQ/SpuuBUAemFI/AAAAAAAABeE/1X_XIfxYSF
E/s288/IMG_1101.JPG” height=“216” width=“288” />

| | |
|---|---|
| | <media:title type=“plain”>IMG_1101.JPG</media:title> |
| | </media:group> |
| | </item> |
| − | <item> |
| | <guid |

isPermaLink=“false”>http://picasaweb.google.com/data/entry/base/user/client/albumid/53760
81899425050153/photoid/5376081935736387714?alt=rss&hl=en_US</guid>

<pubDate>Mon, 31 Aug 2009 11:03:37 +0000</pubDate>
<atom:updated>2009-08-31T11:03:37.596Z</atom:updated>
<category

domain=“http://schemas.google.com/g/2005#kind”>http://schemas.google.com/photos/2007#
photo</category>

<title>IMG_1104.JPG</title>
<description><table><tr><td style=“padding: 0 5px”><a

href=“http://picasaweb.google.com/client/Myparty#5376081935736387714”><img
style=“border:1px solid #5C7FB9”
src=“http://lh3.ggpht.com/_WS2bxyG_TbQ/SpuuCW72OII/AAAAAAAABeI/eiRRkwJ3FGI
/s288/IMG_1104.JPG” alt=“IMG_1104.JPG”/></a></td><td valign=“top”><font
color=“#6B6B6B”>Date: </font><font color=“#333333”>Aug 22, 2009 1:56
AM</font><br/><font color=\“#6B6B6B\”>Number of Comments on Photo:</font><font
color=\“#333333\”>0</font><br/><p><a
href=“http://picasaweb.google.com/client/Myparty#5376081935736387714”><font
color=“#3964C2”>View Photo</font></a></p></td></tr></table></description>

<enclosure type=“image/jpeg”

url=“http://lh3.ggpht.com/_WS2bxyG_TbQ/SpuuCW72OII/AAAAAAAABeI/eiRRkwJ3FGI
/IMG_1104.JPG” length=“0” />

| | |
|---|---|
| | <link>http://picasaweb.google.com/client/Myparty#5376081935736387714</link> |
| − | <media:group> |
| | <media:content |

url=“http://lh3.ggpht.com/_WS2bxyG_TbQ/SpuuCW72OII/AAAAAAAABeI/eiRRkwJ3FGI
/IMG_1104.JPG” height=“768” width=“1024” type=“image/jpeg” medium=“image” />

<media:credit>Client</media:credit>
<media:description type=“plain” />
<media:keywords />
<media:thumbnail

url=“http://lh3.ggpht.com/_WS2bxyG_TbQ/SpuuCW72OII/AAAAAAAABeI/eiRRkwJ3FGI
/s72/IMG_1104.JPG” height=“54” width=“72” />

<media:thumbnail

url=“http://lh3.ggpht.com/_WS2bxyG_TbQ/SpuuCW72OII/AAAAAAAABeI/eiRRkwJ3FGI
/s144/IMG_1104.JPG” height=“108” width=“144” />

<media:thumbnail

url=“http://lh3.ggpht.com/_WS2bxyG_TbQ/SpuuCW72OII/AAAAAAAABeI/eiRRkwJ3FGI
/s288/IMG_1104.JPG” height=“216” width=“288” />

<media:title type=“plain”>IMG_1104.JPG</media:title>
</media:group>
</item>

The above feed for the photos present within the set 5376081899425050153 is retrieved from the server 104. It should be noted that the above exemplary server feed includes information about only two images in the album 5376081899425050153. For example, in the above server feed, the PhotoIDs are 5376081917770635346 and 5376081935736387714. The <pubdate/> section holds the time stamps of these photos. The server feed is parsed, and links to individual photos are extracted, and downloaded. The downloaded photos within the set are stored with the name of their UniquePhotoIDs within the folder named UniqueSetID of the set 5376081899425050153 in the local cache. As described in FIG. 3, the UniquePhotoID may be determined by hashing the PhotoID and time stamp associated with the photo file. Further, a list of resources such as a list of UniquePhotoIDs is computed using the server feed. Further, at 418, UniquePhotoSetID may be determined by hashing the UniqueSetID and the UniquePhotoIDs under the set 5376081899425050153.

Further, at 420, the determined UniquePhotoSetID is compared with a UniquePhotoSetID from the storage memory 106. Herein, the UniquePhotoSetID from the storage memory 106 may be determined by using the stored Unique SetID and UniquePhotoIDs (filenames of the photo files under the set 5376081899425050153) for the images 5376081917770635346 and 5376081935736387714.

If the UniquePhotoSetID determined using the server feed and the UniquePhotoSetID derived from the storage memory 106 match, it may be assumed that any photos have not been deleted or added under the set 5376081899425050153. Accordingly, at 422, the photos under the set 5376081899425050153 may be rendered directly from the cached content, for example, from the storage memory 106. In one embodiment, the list of UniquePhotoID may be used as the reference for order of rendering at the screen of the client apparatus 102.

Further, at 420, if it is determined that the UniquePhotoSetID determined using the server feed and the UniquePhotoSetID derived from the storage memory 106 do not match, the missing photos are identified. An exemplary way of identifying and rendering the missing photos is shown in blocks 424-436.

At 424, each UniquePhotoID of the list of UniquePhotoID from the storage memory 106 (hereinafter referred to as ‘memory list’) is taken one at a time. Further, at 426, each UniquePhotoID from the storage memory 106 is matched with the list of UniquePhotoIDs computed using the server feed (hereinafter referred to as ‘server list’).

Further, at 426, if it is checked that an entry of the memory list is present in the server list. The matching entry is removed from the memory list, for example, from list of UniquePhotoID from the storage memory, at 428. At 428, the server list, for example, the UniquePhotoID list computed using the server is updated as well, by removing the matching entry. Further, the matching entry, for example, the photo file related to the matching UniquePhotoID is rendered immediately from the local cache (storage memory 106) and also displayed at the screen of the client apparatus 102, at 430. Further, at 426, if there is no match found for this entry in the server list, the entry is removed from the memory list, at 432.

It would be apparent to those skilled in the art that the each entry of the memory list (from the storage memory 106) is taken one by one for checking whether the entry is present in the server list. This process is repeated until each of the UniquePhotoIDs in the memory list is compared. The memory list is checked to determine if it is empty after each UniquePhotoID is processed, at 434. If the memory list is not empty, the next entry of the memory list is taken and matched for its presence in the server list. This intermediate process completes once the memory list, for example, the list of UniquePhotoIDs in the storage memory 106 is empty, at 434. Further, it would be apparent to those skilled in the art that the remaining entries in the server list are the list of resources that are not present in the storage memory 106. Further, each remaining entries, for example, the list of resources are fetched using the server feed, stored, and rendered in the screen of the client apparatus 102, at 436. In one embodiment, the UniquePhotoSetID and UniquePhotoID list may be updated in the local cache, at 438. Thereafter, the method 400 terminates at 440 when all photo files are downloaded from the server 104, rendered on the client apparatus 102 and are stored in the storage memory 106.

It should also be understood that identification of the missing photos may also be performed by taking an entry of server list one at a time and checking for the presence of the entry in the memory list. If it is checked that an entry, for example, a UniquePhotoID of the server list is not present in the memory list, it may be inferred that the photo file corresponding to the UniquePhotoID is missing in the local cache. Accordingly, the missing photo file is rendered using the server feed and stored in the local cache. Further, once the photo file corresponding to the entry is rendered, this entry is removed from the server list. It will be obvious to those skilled in the art that, if it is checked that the UniquePhotoID of the server list is present in the memory list, it suggests that the photo file corresponding to the UniquePhotoID is already present in the local cache. Thereafter, the corresponding photo file of the matching UniquePhotoID is rendered from the local cache. Accordingly, such matching and rendering of the entries of the server list is performed until it is verified that the server list is empty, and each UniquePhotoID of the server list is rendered.

Although methods 200 and 400 are explained by assuming content to be photos, however it would be apparent to those skilled in the art the methods 200 and 400 may also be applicable for other type of content that can be stored in the server 104 in form of hierarchical data arrangement and is associated with timestamps. For example, content may also be blog entries. In this case, different hierarchical levels may be name of blogger, different titles of the entries of the blog posts, and the actual blog posts. Each of these blog entries may also be associated with timestamps of their date and time of creation or any subsequent modification. Similarly, content such as videos may be organized in form of collections, one or more sets under each collection and video files under each sets. Further, each video file may be associated with timestamp representing the date of upload of the video file, any modification thereof.

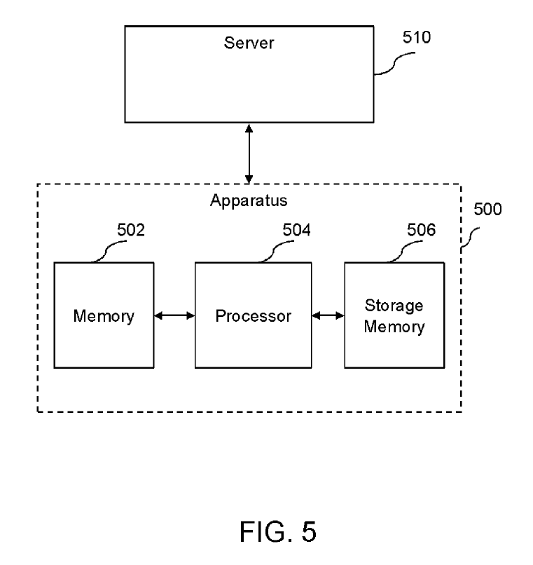

FIG. 5 illustrates a block diagram of an apparatus such as an apparatus 500 for caching of the content from a server, in accordance with an embodiment. It should be noted that the apparatus 500 may be similar to the client apparatus 102 as described in FIG. 1. The apparatus 500 is utilized for caching content from a server 510.

The apparatus 500 is shown to include a memory 502 and a processor 504. However, a person skilled in the art would appreciate that the apparatus 500 can include more than one memory and more than one processor. The memory 502 stores a computer program code. The memory 502 may be a volatile memory or a non volatile memory. Examples of the one or more memory such as the memory 502 include, but are not limited to, a hard drive, a Read Only Memory (ROM), a Random Access Memory (RAM), Erasable Programmable Read-Only Memory (EPROM), Electrically Erasable Programmable Read-Only Memory (EEPROM), Programmable Read-Only Memory (PROM), CD-ROM, or flash memory. In an embodiment, the memory 502 may be permanently implemented within the processor 504.

Example of one or more processors, such as the processor 504 include, but are not limited to, one or more microprocessors, one or more processor(s) with accompanying digital signal processor(s), one or more processor(s) without accompanying digital signal processor(s), one or more special-purpose computer chips, one or more field-programmable gate arrays (FPGAS), one or more controllers, one or more application-specific integrated circuits (ASICS), or one or more computer(s).

The apparatus 500 also includes a storage memory 506 that acts as a local cache memory for storing the cached content and related data from the server 510. The storage memory 506 may also be interchangeably referred to as ‘local cache’. The storage memory 506 may also be implemented as a hard drive, a Read Only Memory (ROM), a Random Access Memory (RAM), Erasable Programmable Read-Only Memory (EPROM), Electrically Erasable Programmable Read-Only Memory (EEPROM), Programmable Read-Only Memory (PROM), CD-ROM, or flash memory. In an embodiment, it may also be possible that the apparatus 500 includes a single memory that can perform the functionality of the memory 502 and the storage memory 506.

The memory 502 and the compute program code, with the processor 504, are configured to cause the apparatus 500 to receive a feed from a server such as server 104 (hereinafter referred to as “server feed”) at the apparatus 500. The server feed is received for accessing a content corresponding to the server feed. It should be noted that herein receiving the server feed may refer to receiving package related to the content. The package may include information and links to various resources of the content. The server feed may be encapsulated in suitable formats such as the XML format. As described in FIGS. 2 and 3, the content may include any data that may be organized in a hierarchical data arrangement. Examples of the content may include, but are not limited to, photos, videos, animations, blog entries and live news updates.

Further, the memory 502 and the compute program code are configured, with the processor 504, to cause the apparatus 500 to determine a UniqueID of at least one hierarchical level of the content using the server feed. As described FIG. 3, the content may be stored in the server 510 in form of a hierarchical data arrangement. For example, a collection may belong to a particular user, and the collection may include multiple albums of the user. Further, each album may include one or more photos of the user. Accordingly, there are three level of hierarchy in the arrangement of photos, for example, the collection, the album and the photos. Each hierarchical level of photos may have Identifier (ID) in the server feed. For example, each collection may be represented by a CollectionID, each set of photos (album) may be represented by a particular SetID, and each photo may be represented by a particular PhotoID.

In an embodiment, UniqueIDs for a hierarchical level may be determined by hashing of timestamp associated with the hierarchical level of the content and a feed portion (ID) corresponding to the hierarchical level of the content in the server feed. For example, UniqueID of a set (album) (hereinafter referred to as ‘UniqueSetID’) may be determined by hashing the timestamp associated with the set and the SetID in the server feed. In one embodiment, the UniqueSetCollectionID may be determined by hashing of the CollectionID and UniqueSetIDs under the collection. Further, UniquePhotoID of the photo may be determined by hashing of the PhotoID and the time stamp associated with the photo in the server feed. In one embodiment, the UniquePhotoSetID may be determined by hashing of the Unique SetID and UniquePhotoIDs under the set, as the next level of hierarchy.

Further, the memory 502 and the compute program code are configured, with the processor 504, to cause the apparatus 500 to compare the determined UniqueID of the hierarchical level to a stored UniqueID of the hierarchical level. It should be noted that the UniqueID can be determined in a real time basis, and the determined UniqueID is compared against the stored UniqueID of the hierarchical level. As described in FIG. 2, the stored UniqueID represents the latest determined UniqueID that is stored in the local cache (storage memory 506). A person skilled in the art would appreciate that it may be determined that whether the content such as photos has been deleted/modified or not based on the comparison of the determined UniqueID and the stored UniqueID of one or more hierarchical levels. As in case of any changes in any collection, set, or photo, their corresponding UniqueIDs will also be changed in the server feed. Accordingly, any changes in the content stored in the local cache and that in the server may be identified based on the comparison of the determined UniqueID and the stored UniqueID of one or more hierarchical levels.

As described in FIG. 2, UniqueIDs for particular hierarchical levels and their related data are stored in the local cached in a manner such that stored UniqueIDs may be compared conveniently with the determined UniqueIDs in a real time basis. For example, when UniqueSetID related to the set and the related data is extracted using the server feed, a folder with name of UniqueSetID of the set may be created in the local cache. In an embodiment, a particular set may also be represented by a thumbnail image. The thumbnail image corresponding to the set may be derived using the server feed. In an embodiment, a UniqueThumbnailID may also be determined by hashing of Unique SetID with a thumbnail resource identifier present in the server feed. Further, the thumbnail image associated with the set may be stored as a file with name of UniqueThumbnailID in the folder of UniqueSetID. Further, downloaded photos within a set may be saved with names of their UniquePhotoID within the folder corresponding to their respective sets.

Once the determined UniqueIDs and the stored UniqueIDs are compared for one or more hierarchical levels of the content, the memory 502 and the compute program code are configured, with the processor 504, to cause the apparatus 500 to facilitate access of the content based on the comparison. Herein, facilitating access of the content may refer to rendering or displaying the content onto a display screen. It should also be noted that rendering may also include playing content at apparatus 102 if the content is multimedia file such as any audio/video file.

In an embodiment, the content is rendered or displayed from the local cache (storage memory 506) if there is a match between the determined UniqueID and the stored UniqueID of the hierarchical level. It should be understood that the determined UniqueID and the stored UniqueID may be matched for one or more hierarchical levels of the content depending upon the type of the content. In an embodiment, only two hierarchical levels such as determined and stored UniqueCollectionIDs, and determined and stored UniqueSetCollectionIDs may be matched, and it may be inferred that there is no changes in the content, and the content may be directly accessed from the local cache. In another example, all three hierarchical levels, the determined and the stored UniqueCollectionIDs, the determined and the stored UniqueSetCollectionIDs, and the determined and the stored UniquePhotoSetIDs may be matched to ensure that there are no changes in a particular collection. Thereafter, the content may be directly accessed from the local cache.

Further, in this embodiment, the content is rendered using the server feed if there is a mismatch between the determined UniqueID and the stored UniqueID of one or more hierarchical levels. It should be noted that when it is determined that the determined UniqueIDs do not match with the stored UniqueIDs, the missing sets are identified. The missing sets are then fetched using the server feed, and rendered on the screen of the client apparatus. In an embodiment, the missing thumbnails associated with the missing sets may also be identified and fetched using the server feed. At the end of this matching process for one or more hierarchical levels, all the missing sets and their associated thumbnails are identified and rendered at a screen of the apparatus 500 using the server feed. A person skilled in the art would appreciate that while comparing the determined UniqueID and the stored UniqueID, only missing sets are rendered using the server feed, whereas the matching sets are rendered from the local cache.

Further if the content such as the sets of the photos are rendered using the server feed, the stored UniqueIDs are updated with the determined UniqueIDs. Further, the content fetched using the server feed also stored in the storage memory 506, which serves as a cached content for next access of the content by the apparatus 500.

In an embodiment, the memory 502 and the compute program code are configured, with the processor 504, to cause the apparatus 500 to identify the missing or modified part of content by comparing a list of resources of the content computed from the sever feed to a list of resources of the content present in the local cache (the storage memory 506). For example, a list of photos can be computed using the server feed. In an embodiment, the list of photos can be computed as list of UniquePhotoIDs. The list of UniquePhotoIDs is compared with the list of UniquePhotoIDs (may be filenames) present in the storage memory 506. Based on the comparison of the list of UniquePhotoIDs computed using the server feed and that stored in the local cache, matching photos and missing photos can be determined.

Accordingly, the content will be rendered from the cache memory in case the list of photos computed using the server feed and the list of photos present the local cache match, for example, it is determined that each of the photos present in the server feed are already present in the local cache. Further, if it is determined that the list of photos computed using the server feed and the list of photos present the local cache do not match, the photo files may be rendered using the server feed. In this situation, it should be noted that only missing photo files of the list of photos are rendered using the server feed, whereas the matching photos of the list of content are directly rendered from the local cache. In this embodiment, the list of photos present in the local cache is updated by the list of photos computed using the server feed, if the content is rendered using the server feed.

The present invention also provides an apparatus for caching of content from a server, in accordance with another embodiment. The apparatus may be a mobile device or any other communication device capable of accessing content from the server, thereby facilitating access of the content. The apparatus may include various means for performing at least one function in accordance with exemplary embodiments, including those more particularly shown and described herein. It should be understood that the apparatus may include alternative means for performing at least one like functions, without departing from the spirit and scope of the present disclosure.

An entity capable of operating as apparatus (for example, the apparatus 500 or the client apparatus 102) may include means for receiving a server feed from a server for accessing a content stored in the server. Further, the apparatus includes means for determining a Unique Identifier (ID) for at least one hierarchical level of the content by parsing the server feed. The apparatus further means for comparing the determined UniqueID of the hierarchical level of the content to a stored UniqueID of the hierarchical level. The apparatus also includes means for facilitating for accessing the content based on the comparison of the determined UniqueID of the hierarchical level to the stored UniqueID of the hierarchical level. Such means of the apparatus may be implemented using hardware, software, firmware, or combination thereof.

Further, the apparatus may also include interface means to connect to the server and a local cache for storing the content fetched from the server. For the sake of brevity of the description, the functionalities of said means for caching of content from the server are not described again as these functionalities are already described in conjunction with the flowchart of methods 200, and 400, and the apparatus 500.

The present disclosure may take the form of a computer program product for caching of content from a server, on a computer-readable storage medium having computer-readable program instructions (e.g., computer software) embodied in the computer-readable storage medium. Any suitable computer-readable storage medium (hereinafter ‘storage medium’) may be utilized including hard disks, CD-ROMs, RAMs, ROMs, Flash memories, optical storage devices, or magnetic storage devices.

The present disclosure is described above with reference to block diagrams and flowchart illustrations of method and apparatus embodying the present disclosure. It will be understood that each block of the block diagram and flowchart illustrations, and combinations of blocks in the block diagrams and flowchart illustrations, respectively, may be implemented by a set of computer program instructions. These set of instructions may be loaded onto a general purpose computer, special purpose computer, or other programmable data processing apparatus to cause an apparatus, such that the set of instructions when executed on the computer or other programmable data processing apparatus create a means for implementing the functions specified in the flowchart block or blocks. Although other means for implementing the functions including various combinations of hardware, firmware and software as described herein may also be employed.

These computer program instructions may also be stored in a computer-readable medium that can cause a computer or other programmable data processing apparatus to function in a particular manner, such that the instructions stored in the computer-readable memory produce an article of manufacture including computer-readable instructions for implementing the function specified in the flowchart of the methods 200 and 400. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart of the methods 200 and 400.

Various embodiments provide methods 200 and 400, apparatus 500, and compute program product for caching of content from a server. These embodiments offer following non-limiting advantages. Various embodiments provide quick-on screen rendering of the content by simply matching UniqueIDs of the content of local cache and the server. Further, various embodiments avoid resource by resource matching that reduces memory overhead and computational complexities in verifying coherency between the server and the local cache. For example, various embodiments follow two step matching process, for example, matching of UniqueIDs for different hierarchical levels and matching of the list of resources of the content.

Further, various embodiments improves user experience by means of optimizations in the client backend for viewing collections from photo sharing services via RSS (or atom) feeds. Various embodiments of the present methods and apparatuses for exploiting the inherent information available in server feed such as the RSS or Atom feeds to keep track of cached data and quickly retrieve such cached data from local cache or the server. The methods and apparatuses proposed by various embodiments of the present invention do not require persistent cache management for content such as Photos, and reduces number of network requests, and reduced the time involved in accessing the desired content by quick on screen rendering.

The foregoing descriptions of specific embodiments have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present disclosure.

What is claimed is:

1. A method comprising:
receiving a server feed from a server for accessing a content;
determining a Unique Identifier (ID) of at least one hierarchical level of the content by parsing the server feed;
comparing the determined UniqueID of the at least one hierarchical level of the content to a stored UniqueID of the hierarchical level; and
facilitating for accessing the content based on the comparison of the determined UniqueID to the stored UniqueID.

2. The method of claim 1, wherein facilitating for accessing the content comprises one of:
rendering the content from a storage memory if there is a match between the determined UniqueID and the stored UniqueID; and
rendering the content using the server feed if there is a mismatch between the determined UniqueID and the stored UniqueID.

3. The method of claim 2 further comprising:
updating the stored UniqueID by the determined UniqueID of the at least one hierarchical level in the storage memory, if there is a mismatch between the determined UniqueID and the stored UniqueID; and
storing the rendered content in the storage memory.

4. The method of claim 1, wherein facilitating for accessing the content comprises:
computing a list of resources of the content using the server feed;
comparing to the list of resources of the content computed using the server feed to a list of resources present in a storage memory; and
performing one of:
rendering the content from the storage memory if there is a match between the list of resources computed using the server feed and the list of resources present in the storage memory; and
rendering the content using the server feed if there is a mismatch between the list of resources using the server feed and the list of resources present in the storage memory.

5. The method of claim 4, further comprising updating the list of resources of the content present in the storage memory by the list of resources of the content computed using the server feed, if there is a mismatch between the list of resources computed using the server feed and the list of resources present in the storage memory.

6. The method of claim 1, wherein the content is a photo.

7. The method of claim 6, wherein the at least one hierarchical level of content comprises at least one of a collection, albums within the collection, and photos within each album.

8. The method of claim 1, wherein the UniqueID is determined by hashing of timestamp associated with the at least one hierarchical level of the content and a feed portion corresponding to the at least one hierarchical level of the content in the server feed.

9. An apparatus comprising:
at least one processor; and
at least one memory comprising computer program code, the at least one memory and the computer program code configured to, with the at least one processor, cause the apparatus at least to perform:
receive a server feed from a server for accessing a content stored in the server;
determine a Unique Identifier (ID) of at least one hierarchical level of the content by parsing the server feed;
compare the determined UniqueID of the at least one hierarchical level of the content to a stored UniqueID of the hierarchical level; and
facilitate for accessing the content based on the comparison of the determined UniqueID to the stored UniqueID.

10. The apparatus of claim 9, further comprising a storage memory, wherein the at least one memory and the computer program code configured to, with the at least one processor, cause the apparatus at least to:
render the content from the storage memory if there is a match between the determined UniqueID and the stored UniqueID; and
render the content using the server feed if there is a mismatch between the determined UniqueID and the stored UniqueID.

11. The apparatus of claim 10, wherein the at least one memory and the computer program code configured to, with the at least one processor, cause the apparatus at least to perform:
update the stored UniqueID by the determined UniqueID of the at least one hierarchical level in the storage memory, if there is a mismatch between the determined UniqueID and the stored UniqueID; and
store the rendered content in the storage memory.

12. The apparatus of claim 9, wherein the at least one memory and the computer program code configured to, with the at least one processor, cause the apparatus at least to:
compute a list of resources of the content using the server feed;
compare to the list of resources of the content computed using the server feed to a list of resources present in a storage memory; and
perform one of:
render the content from the storage memory if there is a match between the list of resources computed using the server feed and the list of resources present in the storage memory; and
render the content using the server feed if there is a mismatch between the list of resources using the server feed and the list of resources present in the storage memory.

13. The apparatus of claim 12, wherein the at least one memory and the computer program code configured to, with the at least one processor, further cause the apparatus at least to update the list of resources of the content present in the storage memory by the list of resources of the content computed using the server feed, if there is a mismatch between the list of resources computed using the server feed and the list of resources present in the storage memory.

14. The apparatus of claim 9, wherein the content is a photo.

15. The apparatus of claim 14, wherein the at least one hierarchical level of the content comprises at least one of a collection, albums within the collection, and photos within each album.

16. The apparatus of claim 9, wherein the at least one memory and the computer program code configured to, with the at least one processor, cause the apparatus at least to determine the UniqueID by hashing of timestamp associated with the at least one hierarchical level of the content and a feed portion corresponding to the at least one hierarchical level of the content in the server feed.

17. A computer program product comprising at least one computer-readable storage medium, the computer-readable storage medium comprising a set of instructions configured to cause an apparatus to at least:
receive a server feed from a server for accessing a content stored in the server;
determine a Unique Identifier (ID) of at least one hierarchical level of the content by parsing the server feed;
compare the determined UniqueID of the at least one hierarchical level of the content to a stored UniqueID of the hierarchical level; and
facilitate for accessing the content based on the comparison of the determined UniqueID to the stored UniqueID.

18. The computer program product of claim 17, wherein the set of instructions are further configured to cause the apparatus at least to:
render the content from a storage memory if there is a match between the determined UniqueID and the stored UniqueID; and
render the content using the server feed if there is a mismatch between the determined UniqueID and the stored UniqueID.

19. The computer program product of claim 18, wherein the set of instructions are further configured to cause the apparatus at least to perform:
update the stored UniqueID by the determined UniqueID of the at least one hierarchical level in the storage memory, if there is a mismatch between the determined UniqueID and the stored UniqueID; and
store the rendered content in the storage memory.

20. The computer program product of claim 17, wherein the set of instructions are further configured to cause the apparatus at least to:
compute a list of resources of the content using the server feed;
compare to the list of resources of the content computed using the server feed to a list of resources present in a storage memory; and
perform one of:
render the content from the storage memory if there is a match between the list of resources computed using the server feed and the list of resources present in the storage memory; and
render the content using the server feed if there is a mismatch between the list of resources computed using the server feed and the list of resources present in the storage memory.
